(19) United States
(12) Patent Application Publication
(10) Pub. No.: US 2009/0187942 A1
(43) Pub. Date: Jul. 23, 2009

(54) RECEIVING APPARATUS

(76) Inventors: Noboru Wakabayashi, Yokohama (JP); Sadao Tsuruga, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/357,511

(22) Filed: Jan. 22, 2009

(30) Foreign Application Priority Data
Jan. 22, 2008 (JP) 2008-011057
Jan. 22, 2008 (JP) 2008-011058

(51) Int. Cl. H04N 5/445; H04N 5/91; H04N 7/173

(52) U.S. Cl. 725/39; 386/83; 386/94; 725/134

(57) ABSTRACT

An apparatus operable with taking an allowable number of copies information into consideration. Provided is a receiving apparatus including a receiving unit configured to receive programs in a plurality of broadcast networks and data including information of the programs, a program guide preparing unit configured to prepare a program guide based on the information of the programs, and a display controlling unit configured to control a program guide prepared by the program guide preparing unit to be displayed, wherein: the display controlling unit controls information relating to copy control according to the broadcast networks to be displayed on the program guide.

### INCORPORATION BY REFERENCE

The present application claims priority from Japanese application JP 2008-011057 and JP 2008-011058 filed on Jan. 22, 2008, the content of which is hereby incorporated by reference into this application.

### BACKGROUND OF THE INVENTION

The technical field of the present invention relates to a receiving apparatus of programs. More particularly, the technical field relates to a technology of copy control in the apparatus.

In the technical field, Japanese Patent Application Laid-Open No. 2006-114090 (JP-A-2006-114090, hereinafter) describes such a problem that “provided is a device and method which realize restriction of recording of digital information having a copyright to be protected, onto a recording medium in a recording and reproducing device”. As a solution, JP-A-2006-114090 describes that “when copy control information is (Copy one generation), a recording and reproducing control circuit records the above information together with converted digital information in which the information is converted to a preset bit rate, and information on the number of times of copying on the recording medium”. Also, there is described that “when it is (Copy no more) and nonetheless the digital information or the converted digital information is to be moved to the recording medium of the recording device connected to a reproducing device in accordance with the copy control information, the number of times of permission is reduced and the information on the number of times of copying is updated, and digital information signals or the converted digital information and the copy control information and the information on the number of times of copying are again recorded on the recording medium and the digital information signals or the converted digital information are made nonreproducible”.

Further, Japanese Patent Application Laid-Open No. 2006-244603 (JP-A-2006-244603, hereinafter) describes a method of providing a device for storing/recording, capable of achieving both of the user-friendliness and the right protection of copyright holder with respect to contents of “copying is permitted only for one generation. Also, there is described a diagram showing that copyright management information is described and displayed in and on a program information list and the user-friendliness is improved.

### SUMMARY OF THE INVENTION

In recent years, digital broadcasting becomes widely used and various recording media are distributed. Further, various forms of viewing digital contents are adopted. From a viewpoint of copyright protection under the above environment, the data to be transmitted and received among a plurality of recording and reproducing devices and recording media is considered to be controlled by using copy control information. However, control based on the copy control information is performed in a complicated determination of whether a copy is permitted between any devices, and therefore, reduces user-friendliness. In a digital information recording and reproducing method disclosed in JP-A-2006-114090, the allowable number of copies of digital information in which the copy control information is Copy Once Generation is managed and information on the allowable number of copies is displayed to the user, thereby improving the user-friendliness.

However, in a digital information recording and reproducing apparatus disclosed in JP-A-2006-114090, there is supposed only that the copy control information and/or allowable number of copies in the digital data recorded in the recording medium is displayed to the user. However, a description is not made on a user display method during a reservation of the recording operation before performing the recording operation. Further, in the digital information recording and reproducing apparatus disclosed in JP-A-2006-244603, only copy generation management information is supposed as the copy control information; however, means for displaying the information on the allowable number of copies to the user is not disclosed.

In the above-described case, when the copy control information is different from each other, for example, in reserving a recording operation of programs and in performing a reserve-recording operation of programs, the user is likely to incorrectly select a medium as a recording destination. As a result, the apparatuses are not user-friendly.

To accomplish the above-described problems, according to one aspect of the present invention, for example, there is provided a receiving apparatus. The receiving apparatus, comprises:

a receiver configured to receive information of a plurality of programs and each copy control information of the plurality of programs;

a reservation video recording section configured to reserve a recording operation so as to record the program onto a recording medium; and

a recording control unit configured to control the recording operation to be performed onto the recording medium, wherein:

when the copy control information of the program is changed, the recording control unit controls a recording destination to be changed to a recording medium different from the recording medium.

Further, according to another aspect of the present invention, for example, there is provided a receiving apparatus. The receiving apparatus, comprises:

a receiving means configured to receive programs in a plurality of broadcast networks and data including information of the programs;

a program guide preparing means configured to prepare a program guide based on the information of the programs; and

a display controlling means configured to control a program guide prepared by the program guide preparing means to be displayed, wherein:

the display controlling means controls information relating to copy control according to the broadcast networks to be displayed on the program guide.

According to the above-described means, even when the copy control information is different from each other, for example, in reserving a recording operation of programs and in performing a reserve-recording operation of programs, the user-friendly receiving apparatus can be provided.

Further, the allowable number of copies information can be displayed on the program guide and therefore, the user can select a program having a number of allowed numbers of copies at the time of reserving programs.

### BRIEF DESCRIPTION OF THE DRAWINGS

FIG. 1 is a block diagram showing a configuration example of a system.

FIG. 2 is a block diagram showing a configuration example of a transmitting apparatus 1.

FIG. 3 is an example of a configuration of a content use descriptor as one of copy control information units.

FIG. 4 is a transmission operation rule as a description example in each field of the content use descriptor.

FIG. 5 is an example of a configuration of a digital copy control descriptor as one of the copy control information units.

FIG. 6 is digital copy control information as an example of information for controlling a copy generation.

FIG. 7 is a reception processing reference as an example of a reception processing in a receiving apparatus 3 of each field of the content use descriptor transmitted from the transmitting apparatus 1.

FIG. 8 is an operation example of a protection of program contents when the transmitting apparatus 1 uses the copy control information.

FIG. 9 is an example of control in the case where the receiving apparatus 3 uses the copy control information to store (record) the program contents.

FIG. 10 is a block diagram showing a configuration example of a recording and reproducing apparatus 10.

FIG. 11 is a block diagram showing a configuration example of a recording and reproducing control unit 104.

FIG. 12 is a schematic diagram showing a configuration example of information stored in a removable recording medium.

FIG. 13 is a schematic diagram showing a configuration example of information stored in a removable recording medium.

FIG. 14 is a schematic diagram showing a screen example displaying a list of broadcast-scheduled programs.

FIG. 15 is a schematic diagram showing a screen example displaying detailed information of programs.

FIG. 16 is a schematic diagram showing a screen example displaying a setting of a program search.

FIG. 17 is a schematic diagram showing a screen example displaying a list of program search results.

FIG. 18 is a schematic diagram showing a screen example displaying a list of broadcast-scheduled programs.

FIG. 19 is a schematic diagram showing a screen example displaying detailed information of programs.

FIG. 20 is a schematic diagram showing a screen example reporting the possibility that the copy control information is changed.

FIG. 21 is one example of a program content copy control table.

FIG. 22 is a block diagram showing a configuration example of a system according to the third embodiment of the present invention.

FIG. 23 is a block diagram showing a configuration example of the recording and reproducing apparatus 10 according to the fourth embodiment of the present invention.

FIG. 24 is a block diagram showing a configuration example of the recording and reproducing apparatus 10 according to the fifth embodiment of the present invention.

### DESCRIPTION OF THE EMBODIMENTS

Hereinafter, preferred embodiments of the present invention will be described. In this connection, the present invention is not limited to the present embodiments. The present embodiment mainly relates to the treatment of information in which a copy is permitted for one generation.

### First Embodiment

The present embodiment is one embodiment of a receiving apparatus according to the present invention. Hereinafter, the present embodiments are categorized into a system, a transmitting apparatus, copy control information, a receiving apparatus, and a screen display process of program guide, program details, and program search, and further, each part will be described with reference to figures.

### <System>

A system according to the present embodiment will be described with reference to FIG. 1. FIG. 1 is a block diagram showing a configuration example of the system according to the present embodiment. FIG. 1 exemplifies the case in which information is transmitted and received via broadcasting and is recorded and reproduced. In this connection, it is not limited to the broadcasting and the information may be transmitted and received via VOD (Video On Demand) based on the communication and it is generically named a distribution.

The numeral 1 denotes a transmitting apparatus installed in an information service station such as a broadcasting station, the numeral 2 denotes a relay device installed in a relay station or a satellite for broadcasting, the numeral 3 denotes a receiving apparatus installed in a user's house, and the numeral 10 denotes a reception recording and reproducing section that is incorporated in or externally attached to the receiving apparatus 3. The reception recording and reproducing section 10 can record and reproduce broadcasted information.

The transmitting apparatus 1 transmits signal waves modulated through the relay device 2. Transmission, for example, by cables, telephone lines, ground wave broadcasting or the like may be used. This signal waves received by the receiving apparatus 3 are demodulated, and then the demodulated information signals are converted to signals suitable for being recorded, as needed, as described later. When the display is incorporated into the receiving apparatus 3, a user can view video and audio shown by information signals on this display or when the display is not incorporated into the receiving apparatus 3 by connecting the display that is not shown in the figure to the receiving apparatus 3.

### <Transmitting Apparatus>

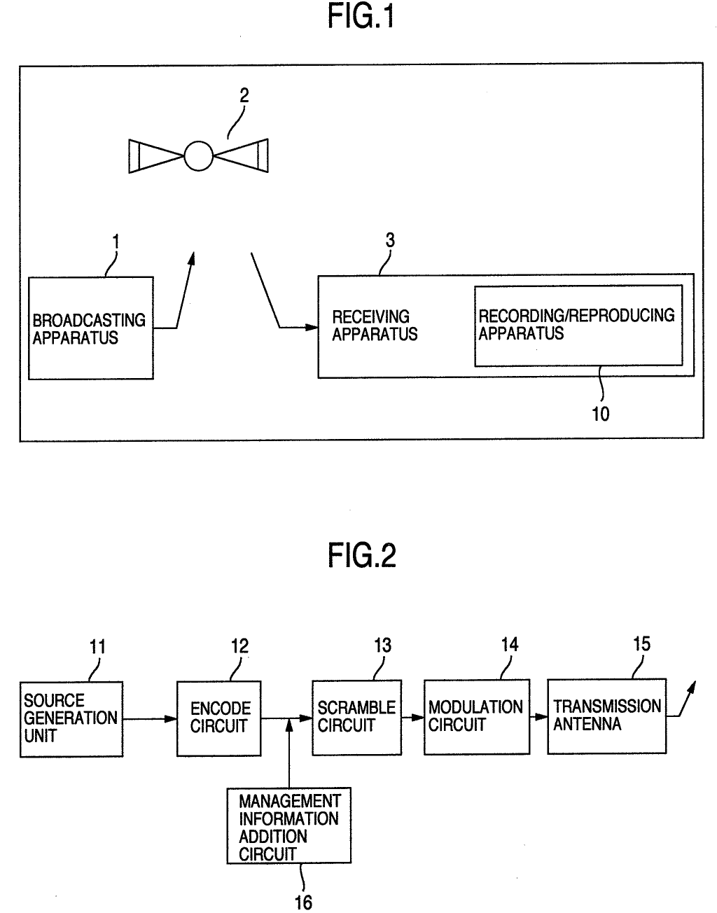

The transmitting apparatus according to the present embodiment will be described with reference to FIG. 2. FIG. 2 is a block diagram showing a configuration example of the transmitting apparatus 1 in the system shown in FIG. 1. The numeral 11 denotes a source generation unit, the numeral 12 denotes an encode circuit for compressing signals by the MPEG system, the numeral 13 denotes a scramble circuit, the numeral 14 denotes a modulation circuit, the numeral 15 denotes a transmission antenna, and the numeral 16 denotes a management information addition circuit. Video and audio information and the like generated in the source generation unit 11 comprising a camera, a recording and reproducing apparatus and the like are compressed in the encode circuit 12 so that the information can be transmitted in a less occupied band. The compressed data is encrypted for transmission in the scramble circuit 13 as needed so that only specific viewers can view the information. The information data is modulated in the modulation circuit 14 so that signals are suitable for transmission, and then the modulated signals are transmitted as radio waves from the transmission antenna 15 toward the relay device 2. At this time, the copy control information as information for controlling copies, information such as a current time, or information of broadcast programs is added by the management information addition circuit 16. The information of this broadcast program includes not only information of programs to be transmitted but also information on a broadcast-scheduled program such as information on a one-week program.

A plurality of information units are multiplexed on one radio wave in a time division system, a spread spectrum system, or the like in most cases. Although not shown in FIG. 2 for the sake of simplification, in this case, a plurality of channels are provided between the source generation unit 11 and the encode circuit 12, and a multiplex circuit for multiplexing a plurality of information units is provided between the encode circuit 12 and the scramble circuit 13.

### <Copy Control Information>

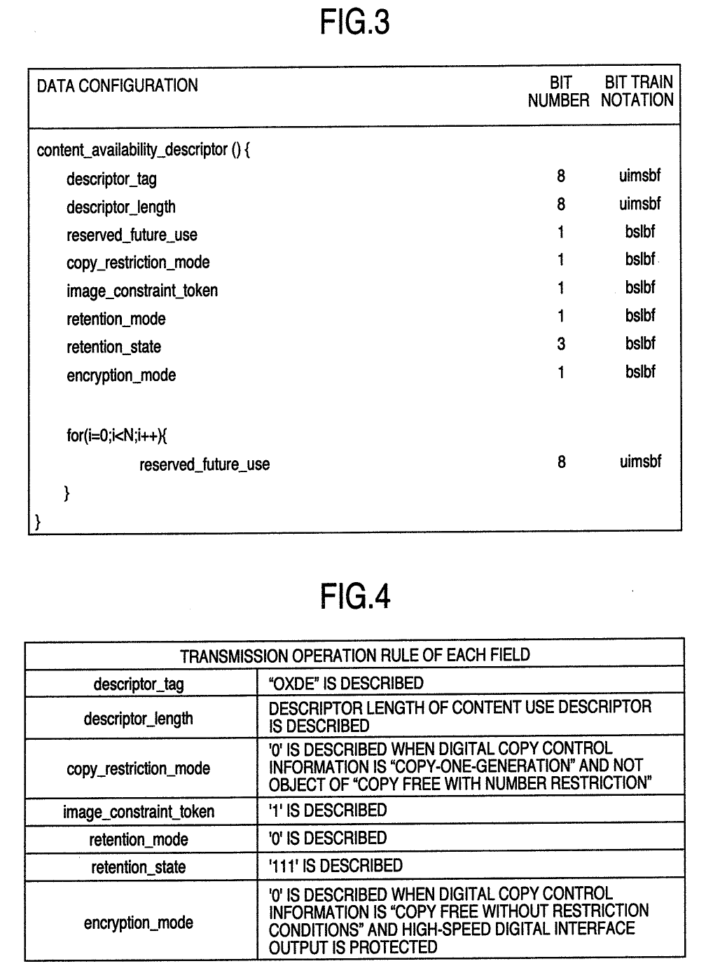

The copy control information according to the present embodiment will be described with reference to FIGS. 3 to 9. The copy control information is information for controlling the restriction such as the propriety or number of copies, and added, for example, by the management information addition circuit 16. The copy control information includes a content use descriptor and a digital copy control descriptor.

FIG. 3 is one example showing a configuration of the content use descriptor as one of the copy control information units. The content use descriptor is information that is generated and added, for example, by the management information addition circuit 16 and stored in the PSI (Program Specific Information) (PMT (Program Map Table) as one example) of MPEG-TS or SI (Service Information) to be transmitted. The SI also includes information on a broadcast-scheduled program and a program guide is prepared in reference to the SI. For utility of the content use descriptor, the descriptor is arranged (transmitted) toward the program in the case of describing control information in relation to storages (records) or outputs. The descriptor means the following. That is, when “1” is placed in the field of one bit of the copy_restriction_mode, the recording operation is allowed as “Copy free with number restriction” even if the digital_recording_control_data of the digital copy control descriptor explained in FIG. 5 is “Copy one generation”. “Copy free with number restriction” means that any of contents having been recorded in a recording medium can be copied in a predetermined number of times. Meanwhile, when “0” is placed in the field of one bit of the copy_restriction_mode, the recording operation is not allowed as “Copy free with number restriction”.

The content use descriptor, when the program is an object of output protection, is necessarily arranged (transmitted). This output protection means that the protection is performed toward a high-speed digital interface output of contents with “Copy free without restriction conditions” using an output protection bit (encryption_mode) of the content use descriptor. To put it another way, even if the encryption is performed during outputs in the digital interface or copying to the recording medium, restrictions are not imposed on the number or generation of copies. Retransmission to the Internet is actually impossible. It is also called “Copy free with output protection” or EPN (encryption plus non-assertion). Further, when the digital copy control information of the program is “Copy one generation” and not an object of “Copy free with number restriction”, the content use descriptor is necessarily arranged (transmitted).

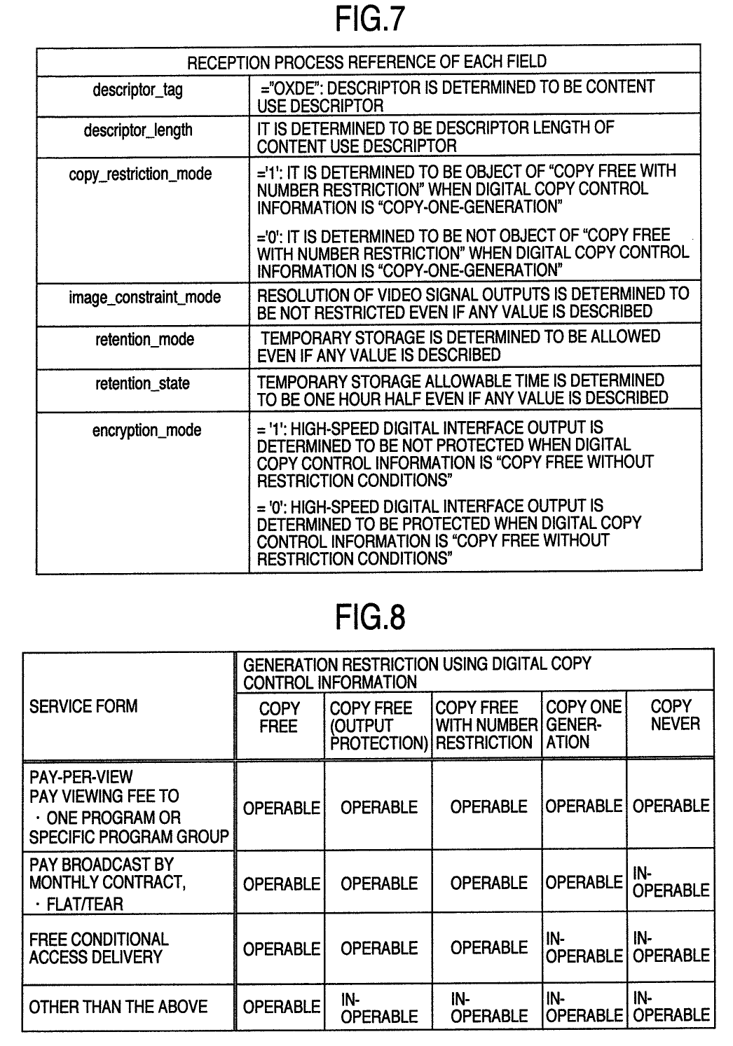

FIG. 4 is one example of description contents in each field of the content use descriptor on the transmission side. In the “descriptor_tag”, “OxDE” that means the content use descriptor is described. In the “descriptor_length”, a descriptor length of the content use descriptor is described. In the “copy_restriction_mode”, ‘0’ is described when the digital copy control information of the program is “Copy one generation” and not an object of “Copy free with number restriction”. In the “copy_restriction_mode”, ‘1’ is described when the digital copy control information of the program is “Copy one generation” and an object of “Copy free with number restriction”. In the “encryption mode”, ‘0’ is described when the digital copy control information is “Copy free without restriction conditions” and the protection is performed toward the high-speed digital interface output. “Retention_mode” means a temporary storage control bit and in the mode, described is ‘0’ representing that a temporary storage is possible even if “digital_recording_control_data” (digital copy control information) of the digital copy control descriptor is “Copy never”. “Retention state” means a temporary storage allowable time and in the state, described is “111” representing that storage of one hour half is allowed. In the “image_constraint_token”, the “retention_state”, and the “encryption_mode”, “1” is described in a default state. Each field will be described below as a process on the reception side also with reference to FIG. 7.

FIG. 5 is one example showing a configuration of the digital copy control descriptor as one of the copy control information units. The digital copy control descriptor is information that is generated and added, for example, by the management information addition circuit 16 and stored in the PSI (PMT as one example) or SI of MPEG-TS to be transmitted.

The digital copy control descriptor is described in the field of two bits of the “digital_recording_control_data” (digital copy control information) and represents information for controlling a copy generation.

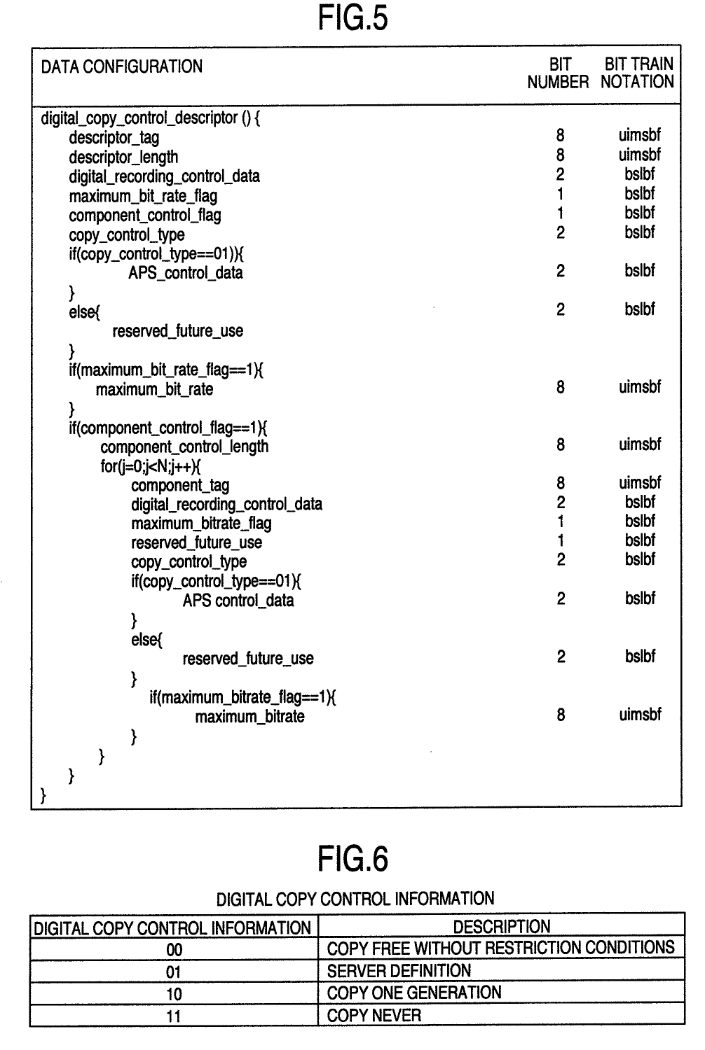

FIG. 6 is one example of the digital copy control information “digital_recording_control_data”. The digital copy control information represents “Copy free without restriction conditions” in the case of “00”, information according to the definition of broadcast servers in the case of “01”, “Copy one generation” in the case of “10”, and “Copy never” in the case of “11”. In addition, “Copy one generation” means that received broadcast signals can be recorded (First generation copy) and the broadcast signals cannot be copied after the recording operation.

The content use descriptor of FIGS. 3 and 4 is also called copy number restriction information, and the digital copy control information of FIGS. 5 and 6 is also called copy generation restriction information.

Detailed examples of the process of the receiving apparatus 3 relating to the copy control information described in FIGS. 3 to 6 which are transmitted from the transmitting apparatus 1 will be described. In addition, “Server Definition” of FIG. 6 can be defined independently by the broadcast server. Further, “Copy one generation” means that received broadcast signals can be recorded (First generation copy) but the recorded signals cannot be copied.

FIG. 7 is one example of the process in each field of the content use descriptor in the receiving apparatus 3. When “OxDE” is described in the “descriptor_tag”, the descriptor is determined to be the content use descriptor. By the “descriptor_length”, it is determined to be a descriptor length of the content use descriptor. In the case where ‘1’ is described in the “copy_restriction_mode”, when the digital copy control information is “Copy one generation”, it is determined to be an object of “Copy free with number restriction”. In the case where ‘0’ is described in the “copy_restriction_mode”, when the digital copy control information is “Copy one generation”, it is determined to be not an object of “Copy free with number restriction”. Even if any value is described in the image_constraint_token, the resolution of video signal outputs is determined to be not restricted. Even if any value is described in the “retention_mode”, a temporary storage is determined to be allowed. Even if any value is described in the “retention state”, the temporary storage allowable time is determined to be one hour half. In the case where ‘1’ is described in the “encryption_mode”, when the digital copy control information is “Copy free without restriction conditions”, the protection is determined to be not performed to the high-speed digital interface output. In the case where ‘0’ is described in the encryption mode, when the digital copy control information is “Copy free without restriction conditions”, the protection is determined to be performed to the high-speed digital interface output.

When the content use descriptor is not arranged (transmitted) for some reason, it may be understood that respective values described in the fields are the following values. That is, the copy_restriction_mode=‘1’, the image_constraint_token=‘1’, the_retention_mode=‘0’, the retention_state=‘111’, and the encryption_mode=‘1’

FIG. 8 shows an example of operations relating to the protection of program contents by using the above-described copy control information. The term “operable” shows that the transmission side can select contents corresponding to respective service forms as a generation restriction using the digital copy control information. The term “operable” shows that any digital copy control information may be used when the service form is, for example, a “pay-per-view”. Meanwhile, the term “operable” shows that the transmission side cannot select the digital copy control information of “Copy never” when the service form is a “pay broadcast by monthly contract”. In flat/tear contracts, it is called a flat contract to contract collectively a plurality of channels in a pay broadcast and it is called a tear contract to contract each channel one by one. The “service form other than the above-described form” includes, for example, the “case of the program that is not a pay broadcast, in which the contents are not protected”.

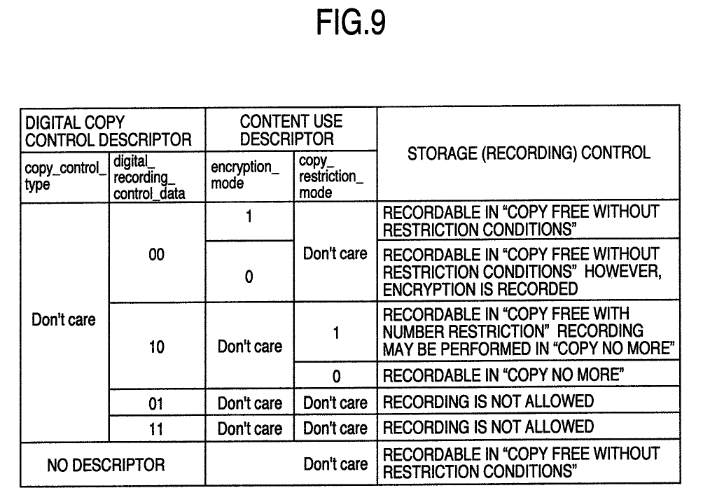

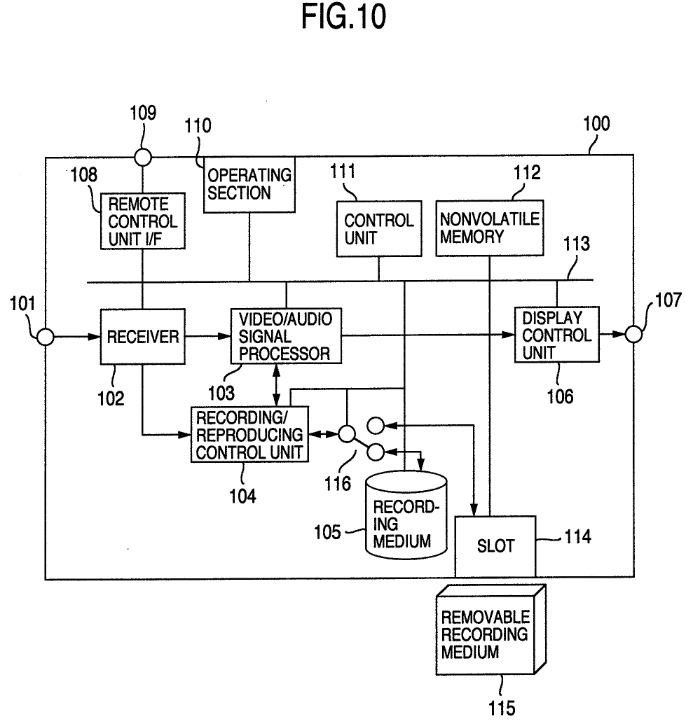

FIG. 9 is one example of a control that the receiving apparatus 3 stores (records) program contents using the copy control information.

As shown in FIG. 9, in storing the program contents, when the digital_recording_control_data of the digital copy control descriptor is ‘10’ representing “Copy one generation”, the copy control information is stored on the recording medium as “Copy no more”. In this connection, when the copy_restriction_mode is ‘1’, the copy control information is stored on the recording medium as “Copy free with number restriction”. In addition, also when the copy control information is stored on the recording medium as “Copy no more”, a value of the digital_recording_control_data of the digital copy control descriptor need not be changed.

Further, when the digital_recording_control_data of the digital copy control descriptor is ‘10’ representing “Copy one generation”, a plurality of copies must not be generated. In this connection, the storage in areas that cannot be accessed by the user for the purpose of the backup is excluded. The above-described restriction is imposed on a broadcasting receiver. When a plurality of broadcasting receivers are provided, the restriction is imposed on each broadcasting receiver.

Relating to the “Copy free with number restriction”, N copies can be generated from the program content that is stored as “Copy free with number restriction”. A value of N may be generated in conformity to, for example, the standard. When the copy is generated via the high-speed digital interface output, the copy may be performed in the case where the number of copies to be generated can be fixed by using the move function. When recognizing that the apparatus corresponds to the interface of IEEE 1394 and the output destination of DTCP (Digital Transmission Content Protection) standard, for example, the copy may be performed. In addition, the generated copy is “Copy no more” or is the same state as that of “Copy no more”.

When the program contents that are stored in the recording medium as “Copy free with number restriction” are reproduced and output, the process of No More Copies that is specified in the DTCP is performed and output in the high-speed digital interface. The analog video outputs and the digital audio outputs can be performed as “Copy one generation”.

When the recording medium is a removable recording medium, another restriction is imposed in addition to those shown in FIG. 9. In relation to the digital recording operation of the program contents onto the removable recording medium, in the digital recording operation of TV and data service, or in the digital recording operation of audio service, when the program contents in which the digital_recording_control_data of the digital copy control descriptor is “10” representing “Copy one generation” is received and recorded, three copies or more are not allowed even if the received content is a first generation (e.g., when the broadcasting is received and recorded, the recording operation must not be performed onto three recording media or more at the same time). This value (e.g., three examples or more) may be used in conformity to, for example, the standard. Further, a plurality of copies of one generation with the same recording format must not be generated. In this connection, there is excluded the digital recording operation that is performed onto an area that cannot be accessed by the user for the purpose of the backup. Further, the recording restriction to the digital recording medium is imposed on the broadcasting receiver. When a plurality of the broadcasting receivers are provided, the above-described restriction is imposed on each broadcasting receiver. When a recording system that does not correspond to the copy_restriction_mode is mounted on the receiving apparatus, the program content in which the copy_control_type of the digital copy control descriptor is ‘01’ and the digital_recording_control_data is ‘10’ is digitally recorded in the treatment of “Copy one generation” regardless of the copy_restriction_mode value of the content use descriptor.

### <Receiving Apparatus>

The receiving apparatus according to the present embodiment will be described with reference to FIGS. 10 to 13.

FIG. 10 shows a configuration example of the recording and reproducing apparatus 100 as one example of the recording and reproducing apparatus 10 within the receiving apparatus 3. The recording and reproducing apparatus may be an apparatus having only any one of the recording and reproducing functions.

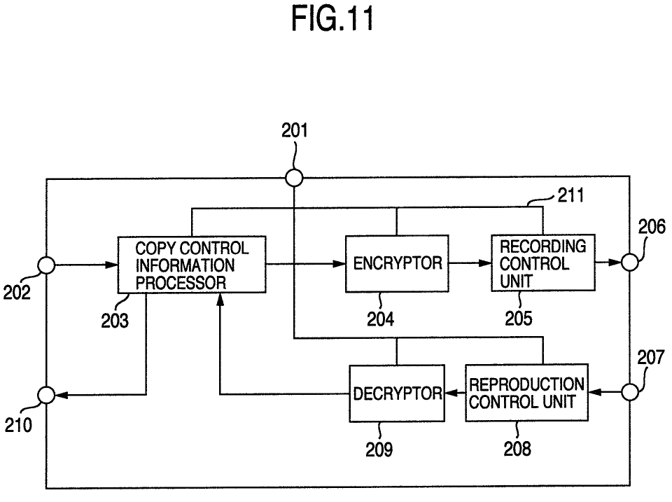

The numeral 101 denotes an input terminal into which digital data such as radio waves transmitted by the relay device 2 is received. The numeral 102 denotes a receiver that performs a frequency conversion, modulation operation, and error correction of the digital data supplied from the input terminal 101. Then, the receiver 102 separates a multiplexed bitstream in one transponder into video packets and audio packets. The numeral 103 denotes a video/audio information processor that decodes video data and audio data. The numeral 104 denotes a recording and reproducing control unit that controls the recording or reproducing of information onto or from a recording medium and FIG. 11 shows one example of a more detailed internal configuration of this module. The numeral 105 denotes a recording medium that records digital data such as a hard disk drive. The numeral 106 denotes a display control unit that generates output data from video/audio data and display data of interface (IF) for various applications. The control unit 106 performs a scaling of the video data processed, for example, by the video/audio processor 103, as needed, and superposes on the video data the image data independently prepared by the recording and reproducing apparatus 100 such as an interface for operation or a still image to generate display images. The numeral 107 denotes an output terminal that transfers generated data to a display device (display unit) such as a liquid crystal panel for display. The numeral 108 denotes a remote control unit IF at the time when the user performs an operation using a remote control unit. The numeral 109 denotes an input terminal that receives signals transmitted from the remote control unit. The numeral 110 denotes an operating section in which a button group for performing an operation such as a recording operation and a reproducing operation is disposed and directly operated by the user to control the recording and reproducing apparatus 100. The numeral 111 denotes a control unit that controls operations of the recording and reproducing apparatus 100 and that comprises, for example, a CPU. The numeral 112 denotes a nonvolatile memory that records information. The numeral 113 denotes a system bus that performs a data communication among respective blocks connected to the control unit 111.

The numeral 114 denotes a slot (it is also called an attaching/detaching section) in which a removable recording medium is made possible to be mounted. The numeral 115 denotes a removable recording medium that performs a recording operation using the same recording format as that of the recording medium 105. The numeral 116 denotes a switch that selects whether to output/input which data of the recording medium 105 and the removable recording medium 115 to/from the recording and reproducing control unit 104. In FIG. 10, only one switch is described and further, it is also considered that respective different switches to be used for input and output are prepared. Alternatively, it is considered a configuration in which the recording and reproducing control units are prepared to the respective recording medium 105 and removable recording medium 115.

FIG. 11 shows a configuration example of the recording and reproducing control unit 104. The numeral 201 denotes an input and output terminal that is connected to the system bus 113 and transmits control signals. The numeral 202 denotes an input terminal that receives digital data including video data and audio data to be recorded in the recording medium. The numeral 203 denotes a copy control information processor that analyses copy control information included in the digital data and updates the information, as needed. The numeral 204 denotes an encryptor that uses key information to be transmitted, for example, by the control unit 111 to thereby encrypt the received digital data. The numeral 205 denotes a recording control unit that issues a command to be recorded in the recording medium and performs a processing such as transferring of the digital data. The numeral 206 denotes an output terminal that is connected to the recording medium. The numeral 207 denotes an input terminal that receives the digital data to be reproduced from the recording medium. The numeral 208 denotes a reproduction control unit that issues a command to the recording medium to reproduce the desired digital data. The numeral 209 denotes a decryptor that decrypts the read-out encrypted digital data using the key information to be transmitted, for example, by the control unit 111. The numeral 210 denotes an output terminal that outputs the decrypted digital data. The numeral 211 denotes a system bus, and is a system bus that performs a data communication between the control unit and respective connected blocks.

When storing the digital data in the recording medium 105, the control unit 111 performs control operations based on the digital copy control descriptor and content use descriptor included in, for example, digital data. The digital copy control descriptor includes, for example, the copy control type and the digital recording control data. The content use descriptor is represented by signals comprising, for example, the encrypted mode and the digital recording control mode. According to values of these descriptors, the control unit 111 instructs the copy control information processor 203 to update the copy control information included in the digital data stored in the processor 203 and further, instructs the encryptor 204 to encrypt/not to encrypt the information.

The copy control information to be processed by the copy control information processor 203 includes, for example, the copy generation management information and the allowable number of copies information. In the copy generation management information, there are possible specification examples of a binary signal as described below, where ‘11’ represents “Copy never” indicating that copies are prohibited, ‘01’ represents “No more copies” indicating that no copies are allowed any more after the recording operation, ‘10’ represents “Copy one generation” indicating that only one generation of contents can be copied, and ‘00’ represents “Copy free” indicating that copies are allowed. It is considered that the information on the allowable number of copies is specified in an integer not less than zero and how many copies are allowed is specified. Further, in the digital data in which the copy generation management information is “Copy free”, one data block that is encrypted and the output of which is protected and another data block that is not encrypted and the output of which is not protected may be present.

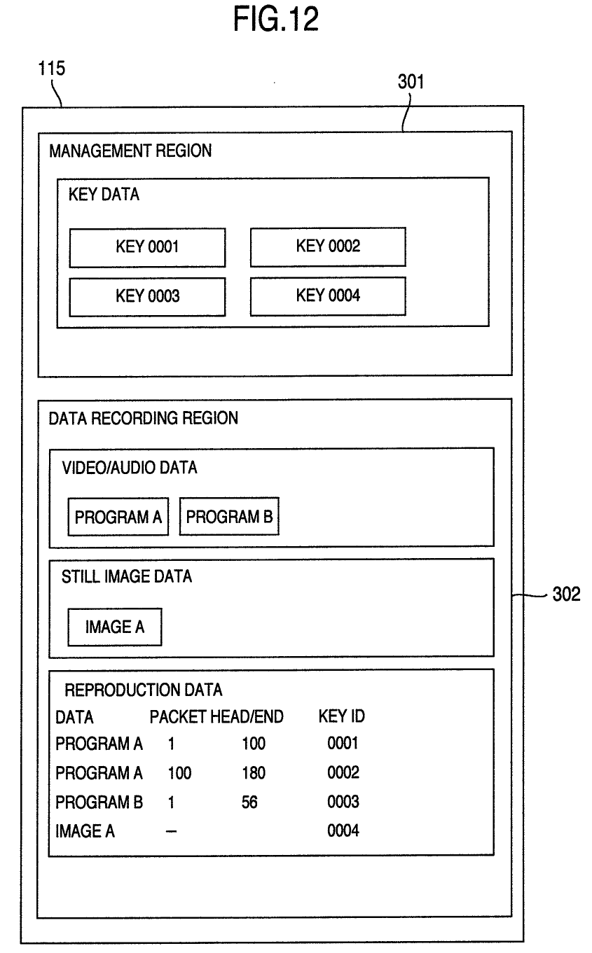

FIG. 12 is one example showing a preferred data configuration of the removable recording medium 115 (e.g., removable hard disk). The numeral 301 is a management region that cannot be accessed by the user. The digital data is encrypted and key data for recording the encrypted data in the data recording region 302 is kept in the management region to thereby keep confidentiality. The numeral 302 denotes a data recording region in which the user can access internal data by performing a predetermined operation. In the region 301, the key data is recorded. In the region 302, data such as video/audio data and still image data as well as information reproduction data for determining the key information corresponding to each data in the data recording region is recorded. In such a removable recording medium 115, the copy control information can also be collectively recorded in the management region 301.

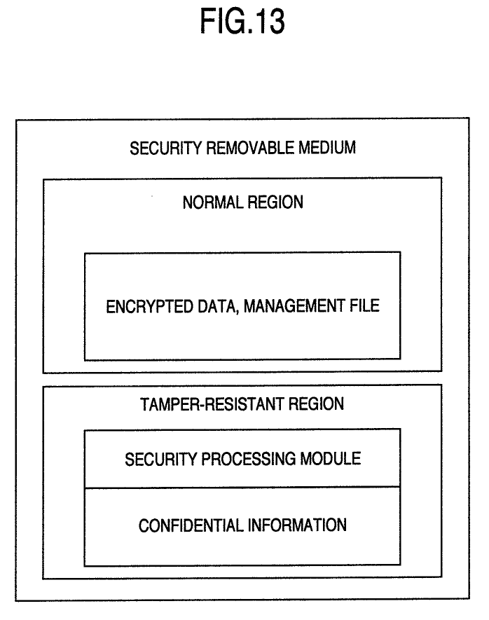

FIG. 13 shows by another expression one example of a preferred data configuration of the recording medium shown in FIG. 12. This recording medium is a recording medium (it is also called a security removable medium) in which a copy can be controlled. The copy control here includes a plurality of copies management (it is also called a copy number management, a copy number control, or a number control copy) and/or a copy generation management (it is also called a copy generation management, a copy generation control, or a generation control copy). One recording medium collectively has a normal region that can be accessed by the user, and a tamper-resistant region that cannot be accessed by the user. When authentication can be confirmed by the authentication process with an apparatus capable of treating this recording medium, confidential information stored in the tamper-resistant region can be accessed, thereby being managed. The management region 301 shown in FIG. 12 corresponds to the tamper-resistant region and the data recording region 302 corresponds to the normal region.

In the recording and reproducing apparatus 100 shown in FIG. 10, there is used the recording medium in which the removable recording medium 115 is different from that shown in FIG. 12 or 13 and the management information or program information relating to, for example, the copy control is likely to be illegally tampered, or there is used the recording medium (the recording medium that is not authorized by the standard that corresponds to the copy control) in which a copy cannot be controlled. In the above-described case, when the digital data that is received from the input terminal 101 is recorded on the recording medium 115 (non-secure recording medium), the control unit 111 controls the copy control information processor 203 to perform the recording operation under the conditions that the copy generation management information is “No-more-copies” and the allowable number of copies information is zero.

### <Image Display Process of Program Guide, Program Details, and Program Search>

The image display process of the program guide, program details, and program search of the receiving apparatus according to the present embodiment will be described with reference to FIGS. 14 to 20.

In the present embodiment, there is considered the case where the user uses the remote control unit or the operating section 110 (the receiver of the remote control unit and the operating section 110 are generically called also the operation input unit) to reserve the recording operation onto the recording and reproducing apparatus 100. Suppose that the digital data received from the input terminal 101 is received, for example, as digital broadcast signals. When digital broadcast signals are recorded on the recording medium, an electronic program guide prepared based on the SI information transmitted from the broadcasting station is used to reserve the recording operation. The above-described way is useful for improving the user-friendliness and therefore, the electronic program guide is generally used to reserve the recording operation in many cases.

When the copy control information is imparted to program contents, the content protection must be performed to record and store the program contents at the time of recording and storing the contents as described also in the <copy control information>. When the content use descriptor or the digital copy control descriptor is inserted into the SI information, the copy generation management information or the allowable number of copies information of a program to be reserved can be grasped during the reservation of the program. Therefore, the recording medium corresponding to the above-described information is selected as a recording destination, or the program in which plural copies are allowed can be selected to be reserved. Meanwhile, when the content use descriptor or the digital copy control descriptor is not inserted into the SI information, the copy generation management information or the allowable number of copies information of a program to be reserved cannot be grasped during the reservation of the program.

Hereinafter, there will be described one example of the process for preparing the electronic program guide in the case where the copy_restriction_mode information of the content use descriptor or information relating to the copy control corresponding to the above-described information on one-on-one level is not included in the SI information.

When the copy control system used in each broadcast network is uniquely determined, for example, when all of the terrestrial digital broadcast programs have “Copy one generation” and “Copy free plural number”, all the terrestrial digital broadcast programs are displayed on the electronic program guide as a program having “Copy one generation” and “Copy free plural number”. One example of the copy control system used in each broadcast network is shown below. Terrestrial digital broadcast programs: “Copy one generation” and “Copy free plural number”, BS free broadcast programs: “Copy one generation” and “Copy free plural number”, CS free broadcast programs: “Copy one generation” and “Copy free plural number”, BS pay broadcast programs: “Copy one generation”, CS pay broadcast programs: “Copy one generation”

A detail of the electronic program guide preparing process in the receiving apparatus 3 will be described below. The digital data received by the input terminal 101 is separated into the video/audio data and the SI information by the receiver 102. The control unit 111 prepares the electronic program guide displayed on the screen based on the SI information (e.g., EIT) separated by the receiver 102. At this time, the control unit 111 includes the copy generation management information and the allowable number of copies information (hereinafter, these are collectively called the copy control information) in the electronic program guide for each broadcast network as described above.

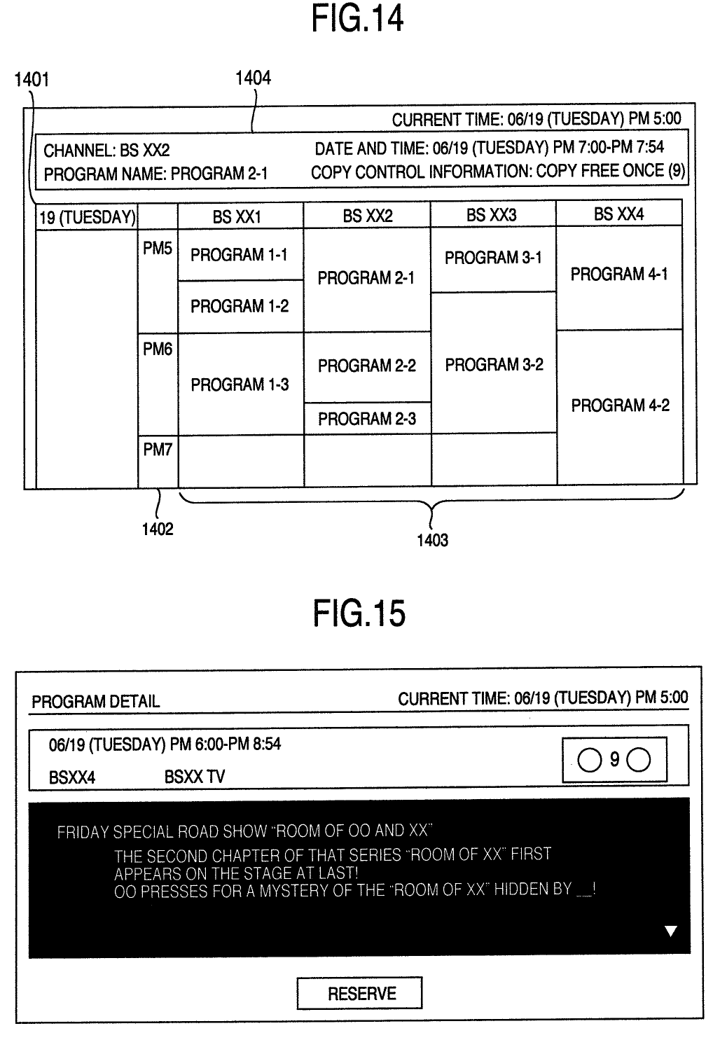

FIG. 14 shows one example of the electronic program guide including the copy control information. The numeral 1401 denotes a date column showing a date and the numeral 1402 denotes a time column showing a time. FIG. 14 shows an example displaying a list of programs from PM 5:00 to PM 7:00 of 19^{th} in the BS free broadcast. The numeral 1403 denotes a broadcast-scheduled program column displaying a broadcast-scheduled program of each broadcasting station and the column is sectioned by a broadcast-scheduled time. The numeral 1404 denotes a program detailed information column displaying program detailed information such as a channel, broadcasting date and time, program name, and copy control information of the program selected by the user using the remote control unit or the operating section 110. In an example of FIG. 14, the copy control information of the program detailed information column 1404 is displayed as a character string of the copy generation information and the allowable number of copies information. In this connection, as to the display method, the information may be displayed using the character string, or using images such as icons (the same is true also on and after FIG. 15). Further, as the copy control information, only the copy generation information may be displayed, or only the allowable number of copies information may be displayed. However, the allowable number of copies information is desired to be displayed (the same is true also on and after FIG. 15).

In an example of FIG. 14, the copy control information is displayed in the program detailed information column 1404 and further, the copy control information may be displayed in each program section of the broadcast-scheduled program column 1403. Thereby, even if the program detailed information column 1404 is not displayed in the list of the program, the copy control information can be identified.

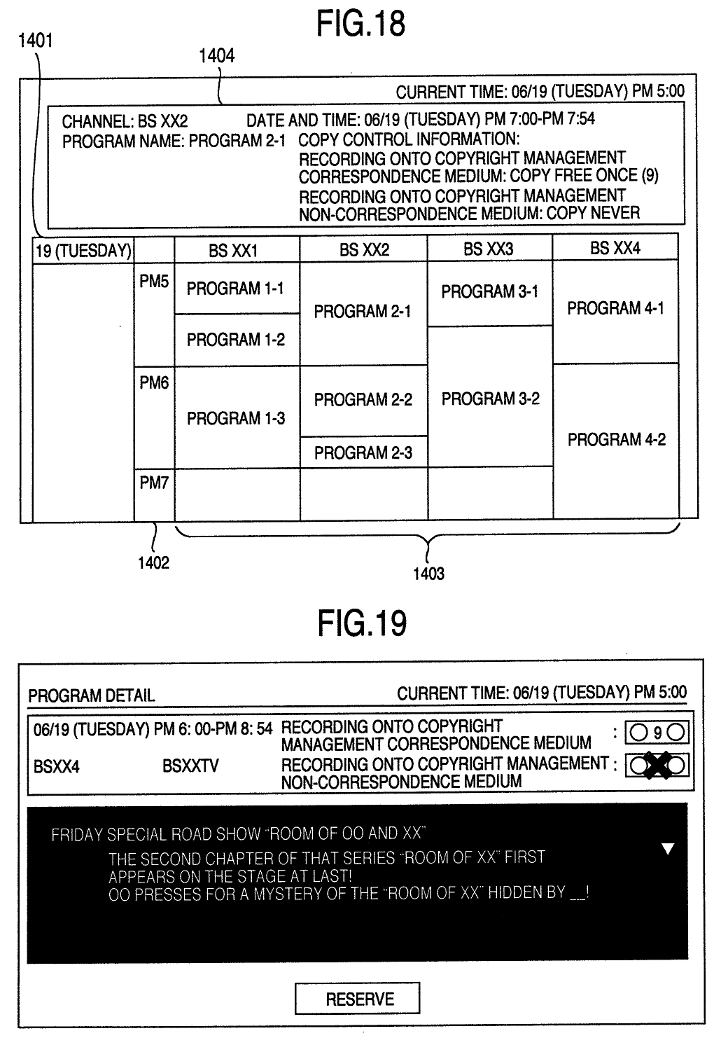

Further, when there is used the recording and reproducing apparatus 100 in which the removable recording medium 115 having no management region that cannot be accessed by the user is allowed, that is, when there is used the recording and reproducing apparatus 100 that performs the recording operation onto a copyright management non-correspondence medium, the copy control information in the case of “performing the recording operation onto the copyright management correspondence medium” and the copy control information in the case of “performing the recording operation onto the copyright management non-correspondence medium” are displayed in the program detailed information column 1404 as shown in FIG. 18. Thereby, the user-friendliness can be improved also to the recording and reproducing apparatus in which the recording operation can be performed onto the copyright management non-correspondence medium.

In an example of FIG. 18, the copy control information is displayed in the program detailed information column 1404 and further, the copy control information may be displayed in each program section of the broadcast-scheduled program column 1403. Thereby, even if the program detailed information column 1404 is not displayed on the list of the program, the copy control information can be identified.

FIG. 15 is one example of the program detailed information screen at the time when the user uses the remote control unit or the operating section 110 to display detailed information of the program. FIG. 15 shows one example of a process for preparing the program detailed information screen at the time when the copy_restriction_mode information of the content use descriptor or information relating to the copy control corresponding to the above-described information on one-on-one level is not included in the SI information.

The digital data received by the input terminal 101 is separated into the video/audio data and the SI information by the receiver 102. The control unit 111 displays the program detailed screen on the screen based on the SI information separated by the receiver 102. At this time, the control unit 111 includes the copy control information of the copy generation management information and the allowable number of copies information in the program detailed screen for each broadcast network as described above. FIG. 15 is an example of the program detailed screen of the BS free broadcast program. In FIG. 15, the copy control information is displayed by an icon; however, as to the display method, the information may be displayed using the character string, or using images other than the icons.

When using the recording and reproducing apparatus 100 in which the removable recording medium 115 having no management region that cannot be accessed by the user is allowed (that is, when using the recording and reproducing apparatus 100 in which the user performs the recording operation onto the copyright management non-correspondence medium), the copy control information in the case of “performing the recording operation onto the copyright management correspondence medium” and the copy control information in the case of “performing the recording operation onto the copyright management non-correspondence medium” are displayed as shown in FIG. 19. In an example of FIG. 19, the copy control information is displayed by icons. FIG. 19 shows that in the case of “performing the recording operation onto the copyright management correspondence medium”, the copy is allowed up to nine copies and in the case of “performing the recording operation onto the copyright management non-correspondence medium”, the copy is not allowed. Thereby, also when using a recording and reproducing apparatus in which the user can perform the recording operation onto the copyright management non-correspondence medium, the user-friendliness can be improved.

FIG. 16 is one example of a program search screen at the time when the user uses the remote control unit or the operating section 110 to search a program from among broadcast-scheduled programs. The numeral 1601 denotes various setting columns for performing various settings in the program search. In the present embodiment, a setting item on the copy control information is provided on the various setting column so as to set the copy control information in a search object. In the copy control information setting of FIG. 16, the user can check “Copy free”, “(one generation) Copy free plural number”, and “Copy never” by check buttons and performs the searching operation by the checked items. When the user checks and searches, for example, “(one generation) Copy free plural number”, only the programs of the “(one generation) Copy free plural number” are displayed as the search results. Needless to say, the user can perform the searching operation by the keywords or by the categories at the same time. In addition, the user can perform a plurality of settings on the copy control information at the same time, or remove all the check marks.

On the occasion of performing the searching operation, with regard to the checked items, when the copy_restriction_mode information of the content use descriptor or information relating to the copy control corresponding to the above-described information on one-on-one level is not included in the SI information, and when the copy control system used for each broadcast network is uniquely determined, the user searches all of the broadcast programs of the broadcast network as the program having the copy control information.

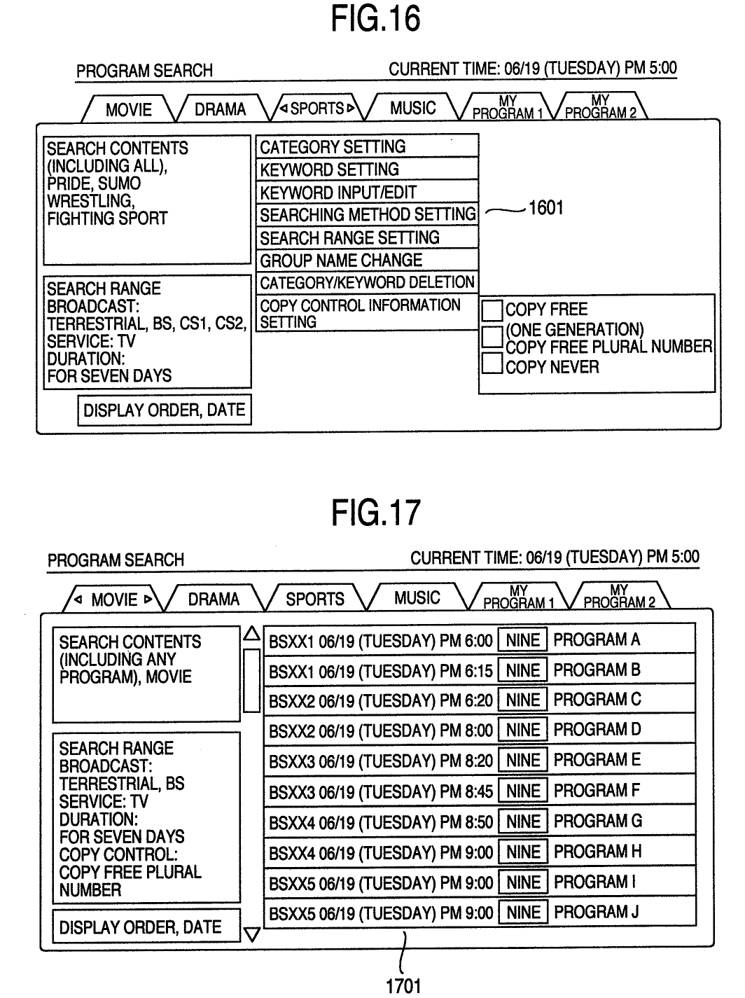

FIG. 17 shows one example of the display screens of the program search results at the time when a program is searched from among the broadcast-scheduled programs. The search results on the copy control information that is set in the copy control information setting items of FIG. 16 is displayed on the list. The numeral 1701 denotes a list display column of the search results and the column displays the search results while including the copy control information for the programs. As to the display method, the results may be displayed using the character string or using the images such as icons. Further, as to the copy control information, only the copy generation information may be displayed or only the allowable number of copies information may be displayed. However, the allowable number of copies information is desired to be displayed.

When the copy_restriction_mode information of the content use descriptor or information relating to the copy control corresponding to the above-described information on one-on-one level is not included in the SI information, and when the copy control system used for each broadcast network is uniquely determined, the copy control systems for each broadcast network are tabulated and managed. The above-described table is stored in the tamper-resistant region that cannot be accessed by the user, thereby protecting the copyright.

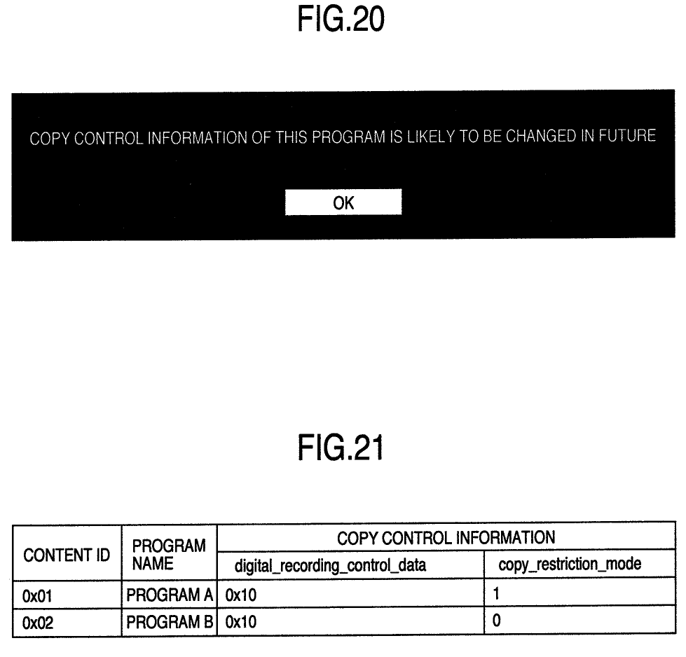

In the BS pay broadcast and the CS pay broadcast, when programs have “Copy one generation” at present and further, “Copy one generation” and “Copy free plural number” in future, that is, when the future operation is undetermined, the message that the copy control information is likely to be changed in future may be displayed at the time of reserving the recording operation of the broadcast network as shown in FIG. 20. Thereby, even when the copy control information is likely to be changed in future, the user can recognize the fact previously and the user-friendliness can be improved.

Next, the case where a program is already recorded on the recording medium is considered as the display method of the information on the allowable number of copies among the copy control information units according to the present embodiment. Suppose that a program with contents equivalent to those of the broadcast-scheduled program is recorded onto the recording medium 105 or the removable recording medium 115 inserted into the slot 114. The programs whose contents are equivalent to each other here mean, for example, two programs that are broadcasted at the same date as that when performing the recording operation using separate apparatuses, or one program that is broadcasted and another program that is rebroadcasted. Whether one program is equivalent to another program is determined as identification data of programs such as a title of a program, a program number, a channel, a broadcast date and time, and a broadcast local region. A length (time) of a program and an analysis result of contents (video/audio data) of a program may be added to determination elements of whether one program is equivalent to another program. It is also represented that the above-described equivalent contents of the one program are duplicated with those of the another program. For its detection, when whether the contents of programs are equivalent to each other is determined, the above-described information units do not necessarily accord with each other completely. When at least a part (e.g., a title) of one program accords with that of another program, whether the programs are equivalent to each other may be determined.

A program with contents equivalent to those of a broadcast-scheduled program is recorded and the copy control information is added to both of the broadcast-scheduled program and the program with the equivalent recorded contents. When information on the allowable number of copies is added to both the programs, the number resulting from adding the allowable number of copies in the broadcast-scheduled program and that in the program with the equivalent recorded contents is displayed as the allowable number of copies of the broadcast-scheduled program in the program guide. For example, when the allowable number of copies of the program with the recorded contents is 6 and that of the broadcasting scheduled program is 9, the allowable number of copies of the broadcast-scheduled program in the program guide is displayed as 15. When the copy control information is not added to the broadcast-scheduled program, the copy control information is not added and displayed to/on the broadcast-scheduled program even if the copy control information is added to the program with the equivalent recorded contents. However, the message to the effect that “the program in which a copy is restricted is recorded onto the recording medium, and do you replace this program by it?” is displayed at the time of reserving the recording operation and the user can select the program. As a result, the user collectively knows information on the program with the equivalent recorded contents, thereby improving the user-friendliness.

### Second Embodiment

In the present embodiment, a process at the time when the copy_restriction_mode information of the content use descriptor or information relating to the copy control corresponding to the above-described information on one-on-one level is not included in the SI information in the first embodiment is performed based on another criterion of judgment. In addition, the system, transmitting apparatus, copy control information, and receiving apparatus according to the present embodiment are the same as those of the first embodiment.

Hereinafter, the screen display process of the program guide, program details, and program search according to the second embodiment of the present invention will be described.

Most of the screen display processes of the program guide, program details, and program search according to the present embodiment are the same as those of the first embodiment. When the copy_restriction_mode information of the content use descriptor or information relating to the copy control corresponding to the above-described information on one-on-one level is not included in the SI information, and when the copy control system used in a broadcast time band for each channel is uniquely determined, the screen display processes will be described.

When the copy control system used in the broadcast time band for each channel is uniquely determined, for example, when all the programs during 8:00 to 10:00 at weekday in 8 channel of the terrestrial digital broadcasting have “Copy one generation” and “Copy free plural number” as the copy control information, all the above-described programs with “Copy one generation” and “Copy free plural number” are displayed on the electronic program guide. Here, all the programs have “Copy one generation” and “Copy free plural number” in the case of weekday and further, the programs with “Copy one generation” and “Copy free plural number” may be changed for each day of the week. Further, when the program has a time band of “Copy one generation” at present, and have a time band of “Copy one generation” and “Copy free plural number” in future, that is, when the future operation is undetermined, the message to the effect that the copy control information is likely to be changed in future may be displayed when the user reserves the recording operation of the programs in the time band of the channel as shown in FIG. 20. Thereby, even when the copy control information is likely to be changed in future, the user can recognize the fact previously and the user-friendliness can be improved.

The copy control system is not determined in the broadcast time band for each channel but it may be uniquely determined for each program. When a serial drama and a news program are determined to be broadcasted every week or every day, for example, the broadcast time band of the program is known to the receiving apparatus side. Therefore, even when the copy_restriction_mode information of the content use descriptor or information relating to the copy control corresponding to the above-described information on one-on-one level is not included in the SI information, the copy control information of the program can be displayed on the electronic program guide. Thereby, the user can reserve the recording operation based on the information.

In addition, the screen display process of the program details and the program search may be performed using the same determination process as that of the copy control information shown in the display process of the electronic program guide. The other processes are the same as those of the first embodiment.

### Third Embodiment

In the present embodiment, a process at the time when the copy_restriction_mode information of the content use descriptor or information relating to the copy control corresponding to the above-described information on one-on-one level is not included in the SI information in the first embodiment is performed based on another criterion of judgment. In addition, the system, transmitting apparatus, copy control information, and receiving apparatus according to the present embodiment are the same as those of the first embodiment.

Hereinafter, the screen display process of the program guide, program details, and program search according to the third embodiment of the present invention will be described.

Most of the screen display processes of the program guide, program details, and program search according to the present embodiment are the same as those of the first embodiment.

There is prepared a program content copy control table where program contents during broadcasting at present on the transmitting side such as a broadcasting station as well as those to be broadcasted after this, and the copy_restriction_mode information of the content use descriptor for its program contents, or information relating to the copy control corresponding to the above-described information on one-on-one level are listed. FIG. 21 shows one example of the program content copy control table. In FIG. 21, content IDs (e.g., event_id of MPEG-2 TS) for uniquely discriminating the program contents and program names are described in the table. However, only the content IDs for uniquely discriminating the program contents may be described. In FIG. 21, only the digital_recording_control_data of the digital copy control descriptor and the copy_restriction_mode of the content use descriptor are described as the copy control information, and further, the whole digital copy control descriptor and the whole content use descriptor may be described in the table, respectively.

The broadcasting station prepares the program content copy control table in which the program content copy control information for a fixed period of time is described. Further, the broadcasting station multiplexes the program content copy control table onto broadcast waves by a multiplex section not shown in FIG. 2, thereby transmitting the multiplexed waves from the transmission antenna 15. The process of the receiving apparatus 100 will be described below.

The digital data supplied to the input terminal 101 is demultiplexed by the receiver 102 into the video/audio data, the SI information, and the program content copy control table that is multiplexed onto the broadcast waves on the transmitting side. The control unit 111 displays the electronic program guide on the screen based on the SI information (e.g., EIT) demultiplexed by the receiver 102. At this time, in the electronic program guide, there is included the copy control information (the copy generation management information and the allowable number of copies information) of the content ID that uniquely discriminates the program contents of the program content copy control table and that accords with the content ID that uniquely discriminates the program contents included in the SI information. In addition, the program contents may be determined not by the content ID but by the program name.

In doing so, even when the copy_restriction_mode information of the content use descriptor or information relating to the copy control corresponding to the above-described information on one-on-one level is not included in the SI information, the copy control information for each program can be grasped and further, the copy control information can be displayed on the electronic program guide. Therefore, the user can select a program to reserve the recording operation based on the copy control information and the user-friendliness can be improved.

In addition, the screen display process of the program details and the program search may be performed using the same determination process as that of the copy control information shown in the display process of the electronic program guide. The other processes are the same as those of the first embodiment.

### Fourth Embodiment

The present embodiment shows the case where a network is used as a transmitting/receiving means of the program content copy control table in the third embodiment. Hereinafter, parts that are different from those of the third embodiment will be described, respectively.

### <System>

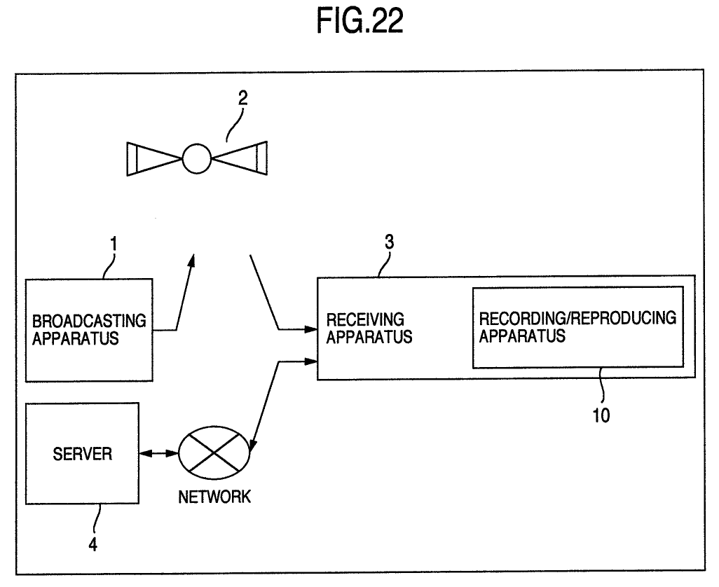

The system according to the present embodiment will be described with reference to FIG. 22. FIG. 22 is a block diagram showing a configuration example of the system according to the present embodiment, and is obtained by adding a server connected to the network to the block diagram of FIG. 1.

The numeral 4 denotes a server provided on the information service station such as the broadcasting station or service provider and the server is connected to the network such as the Internet.

The server 4 preserves the program content copy control table shown in FIG. 21, in which program contents during broadcasting at present as well as those to be broadcasted after this, and the copy_restriction_mode information of the content use descriptor for its program contents, or information relating to the copy control corresponding to the above-described information on one-on-one level is listed. When the connection to the receiving apparatus and the program content copy control table are requested from the receiving apparatus side, the server 4 transmits the program content copy control table via the network according to its request. When receiving the request from the receiving apparatus, the server 4 may perform authentication such as an equipment authentication to transmit the program content copy control table. At this time, the server 4 can perform securer communication. The server 4 can reject a request from a person other than the service provider to thereby limit a service supply range. In relation to parts other than those above, the system according to the present embodiment is the same as that of the third embodiment.

### <Transmitting Apparatus>

The transmitting apparatus according to the present embodiment is the same as that of the third embodiment.

### <Copy Control Information>

The copy control information according to the present embodiment is the same as that of the third embodiment.

### <Receiving Apparatus>

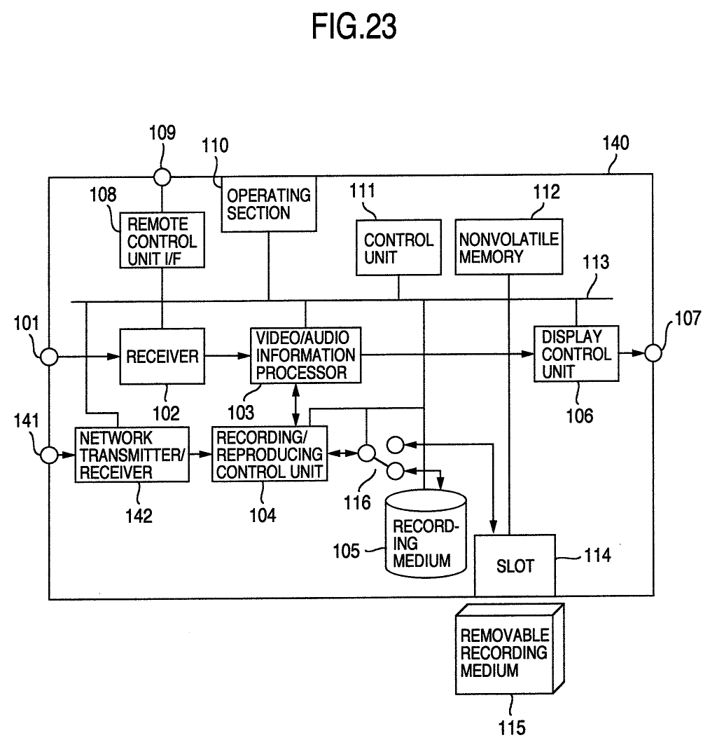

The receiving apparatus according to the present embodiment is the same as that of the third embodiment, and further, the apparatus may be configured as shown in FIG. 23.

The recording and reproducing apparatus of FIG. 23 is almost the same as that shown in FIG. 10; however, an input route of the copy control information toward the recording and reproducing control unit 104 is different from each other. The numeral 141 denotes a network transmission and reception terminal that transmits and receives data via the network such as the Internet. The numeral 142 denotes a network transmitter and receiver that performs analysis and protocol processing of the data that is transmitted and received to and from the network transmission and reception terminal. The network transmitter and receiver 142 is controlled by the control unit 111 that is connected thereto via the system bus. When transmitting the data, the transmitter and receiver transmits the data from the network transmission and reception terminal 141, and performs the protocol processing of the data received from the terminal 141 and then supplies the copy control information to the recording control unit 104.

### <Screen Display Process of Program Guide, Program Details, and Program Search>

Most of the screen display processes of the program guide, program details, and program search in the receiving apparatus according to the present embodiment are the same as those of the third embodiment. A part that is different from that of the third embodiment will be described below.

In the third embodiment, the broadcasting station multiplexes the program content copy control table shown in FIG. 21 onto the broadcast waves to transmit the multiplexed waves; however, in the present embodiment, the broadcasting station transmits the multiplexed waves via the network. Specifically, on the transmitter side such as the broadcasting station, in the server 4, there is prepared the program content copy control table in which program contents during broadcasting at present as well as those to be broadcasted after this, and the copy_restriction_mode information of the content use descriptor for its program contents, or information relating to the copy control corresponding to the above-described information on one-on-one level are listed, and it is in a transmittable state via the network at any given time. On the receiver side, a processing of the broadcast waves is performed in the same manner as in the third embodiment. Further, the receiver side makes a request to the server 4 via the network for the program content copy control table. The server 4 performs the authentication such as an equipment authentication, if necessary, and the receiver side obtains the program content copy control table from the server 4. When the user uses the remote control unit or the operating section 110 to display the electronic program guide, the control unit 111 obtains the SI information from the broadcast waves and displays the electronic program guide on the screen based on the SI information. At this time, in the electronic program guide, there is included the copy control information (the copy generation management information and the allowable number of copies information) of the content ID that uniquely discriminates the program contents of the program content copy control table and that accords with the content ID that uniquely discriminates the program contents included in the SI information. In addition, the program contents may be determined not by the content ID but by the program name.

In doing so, even when the copy_restriction_mode information of the content use descriptor or information relating to the copy control corresponding to the above-described information on one-on-one level is not included in the SI information, the copy control information can be grasped for each program and displayed on the electronic program guide without multiplexing particular information onto the broadcast waves. As a result, the user can select a program to reserve the recording operation based on the copy control information and the user-friendliness can be improved.

The screen display process of the program details and the program search may be performed by the same determination processing as that of the copy control information shown in the display process of the electronic program guide. The other processes according to the present embodiment are the same as those of the third embodiment.

### Fifth Embodiment

In the present embodiment, a process at the time when the copy_restriction_mode information of the content use descriptor or information relating to the copy control corresponding to the above-described information on one-on-one level is not included in the SI information but included in the PSI information in the first embodiment is performed based on another criterion of judgment. In addition, the system, transmitting apparatus, and copy control information according to the present embodiment are the same as those of the first embodiment.

The receiving apparatus and screen display processes of the program guide, the program details, and the program search according to the third embodiment of the present invention will be described below.

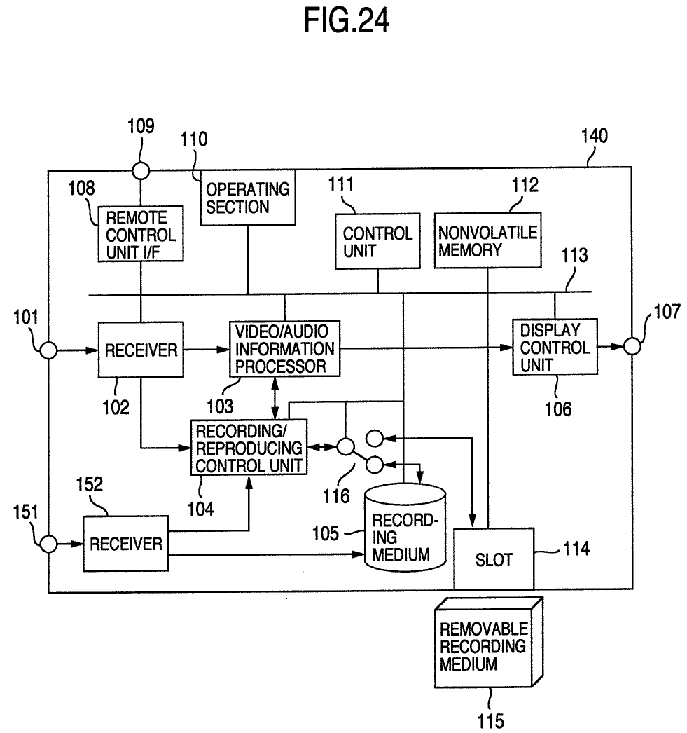

The receiving apparatus according to the present embodiment is almost the same as that of the first embodiment, and has a plurality of the input terminals 101 and a plurality of the receivers 102, respectively, as compared to FIG. 10. For the sake of simplification, the receiving apparatus according to the present embodiment here has two input terminals and two receivers, respectively. FIG. 24 shows a configuration example of a recording and reproducing apparatus 150 in which two input terminals and two receivers are disposed, as compared to FIG. 10.

The numeral 151 denotes an input terminal that has the same function as that of the input terminal 101. The numeral 152 denotes a receiver that has the same function as that of the receiver 102. Specifically, the receiver 102 or 152 performs a frequency conversion, modulation operation, and error correction of the digital data received from the input terminal 101 or 151. Then, the receiver 102 or 152 demultiplexes a multiplexed bitstream in one transponder into video packets and audio packets. The video packets and audio packets demultiplexed by the receiver 102 or 152 are processed by the video/audio information processor 103. Similarly, the copy control information demultiplexed by the receiver 102 or 152 is processed by the recording and reproducing control unit 104. The processing contents are the same as those of the first embodiment.

The screen display process of the program guide, the program details, and the program search will be described below. Most of the screen display processes of the program guide, program details, and program search according to the present embodiment are the same as those of the first embodiment.

Data received by the input terminal 101 of the recording and reproducing apparatus 150 within the receiving apparatus is processed by the receiver 102 and the video/audio information processor 103. Subsequently, the display control unit 106 performs the video/audio output via the output terminal 107. On this occasion, the broadcast waves of all the channels during the broadcasting are circularly received by the input terminal 151 and the receiver 152 that do not perform the video/audio output. Specifically, the input terminal 151 receives the broadcast wave of one channel, and the receiver 152 obtains the copy control information included in the PSI information and content ID (e.g., event id of MPEG-2 TS) for uniquely discriminating the program contents of the program. The program content copy control table in which the obtained content ID and copy control information are listed is prepared and recorded in the recording medium 105 or the removable recording medium 115. The program content copy control table is the same as that shown in FIG. 21. The program name may be described in the table and only the program name may be used in place of the content ID. In addition, the program content copy control table is desired to be recorded in the tamper-resistant region of the recording medium 105 and the removable recording medium 115. The copy control information of the program is added to the program content copy control table. Thereafter, another channel is selected and the same processing as that of the above is performed, and the copy control information of the program is added to the program content copy control table.

Next, a process at the time when the user uses the remote control unit or the operating section 110 to display the electronic program guide will be described. The digital data supplied to the input terminal 101 is demultiplexed to the video/audio data and the SI information by the receiver 102. The control unit 111 displays the electronic program guide on the screen based on the SI information (e.g., EIT) demultiplexed by the receiver 102. At this time, when the copy control information of the content ID is included in the program content copy control table recorded in the recording medium 105 or the removable recording medium 115, the copy control information (the copy generation management information and the allowable number of copies information) is included in the electronic program guide. In addition, the program contents may be determined not by the content ID but by the program name.

In doing so, even when the copy_restriction_mode information of the content use descriptor or information relating to the copy control corresponding to the above-described information on one-on-one level is not included in the SI information, the copy control information of a program (e.g., a news program and a serial drama) to be regularly broadcasted every week or every day, or a program broadcasted once in past times can be grasped. Further, the program content copy control table need not be prepared and a particular apparatus need not be provided on the transmitting side.

As described above, the copy control information can be displayed on the electronic program guide and the user can select a program to reserve the recording operation based on the copy control information. Thereby, the user-friendliness can be improved.

The screen display process of the program details and the program search may be performed using the same determination processing as that of the copy control information shown in the display process of the electronic program guide. The other processes according to the present embodiment are the same as those of the first embodiment.

### Sixth Embodiment

The present embodiment is an embodiment in which the program content copy control table obtained by each means of the third to fifth embodiments is used for the recording and reproducing control in another recording and reproducing apparatus. In addition, the system, transmitting apparatus, copy control information, and receiving apparatus according to the present embodiment are the same as those of the third to fifth embodiments.

The screen display processes of the program guide, program details, and program search according to the sixth embodiment of the present invention will be described below.

Most of the screen display processes of the program guide, program details, and program search according to the present embodiment are the same as those of each embodiment.

The program content copy control table each obtained in each embodiment is first stored in the removable recording medium 115. In addition, the program content copy control table is desired to be stored in the tamper-resistant region of the removable recording medium 115.

The removable recording medium 115 having stored therein this program content copy control table is inserted into the slot 114 provided on the recording and reproducing apparatus within the receiving apparatus according to the present embodiment. The recording and reproducing apparatus according to the present embodiment is the same as that shown in FIG. 10.

The digital data supplied to the input terminal 101 is demultiplexed to the video/audio data and the SI information by the receiver 102. The control unit 111 displays the electronic program guide on the screen based on the SI information (e.g., EIT) demultiplexed by the receiver 102. At this time, when the copy control information of the content ID is included in the program content copy control table recorded in the removable recording medium 115, the copy control information (the copy generation management information and the allowable number of copies information) is included in the electronic program guide. In addition, the program contents may be determined not by the content ID but by the program name.

As described above, when the copy_restriction_mode information of the content use descriptor or information relating to the copy control corresponding to the above-described information on one-on-one level is not included in the SI information, and when a function (third embodiment) of processing the program content copy control table multiplexed onto the broadcast waves is not provided on the recording and reproducing apparatus, or when a function (fourth embodiment) of processing the program content copy control table via the network is not provided on the recording and reproducing apparatus, or even when a function (fifth embodiment) of generating/processing the program content copy control table using the plural input terminals and the plural receivers is not provided on the recording and reproducing apparatus, the copy control information for each program can be grasped. Thereby, the copy control information can be displayed on the electronic program guide and therefore, the user can select a program to reserve the recording operation based on the copy control information to thereby improve the user-friendliness.

The screen display processes of the program details and the program search may be performed using the same determination processing as that of the copy control information shown in the display process of the electronic program guide. The other processes according to the present embodiment are the same as those of the first embodiment.

### Seventh Embodiment

The present embodiment is an embodiment relating to the process of the recording and reproducing apparatus at the time of starting the reserve-recording operation. In addition, the system, transmitting apparatus, copy control information, receiving apparatus, and screen display processes of the program guide, the program details, and the program search according to the present embodiment are the same as those of the first embodiment.

The process of the recording and reproducing apparatus at the time of starting the reserve-recording operation according to the seventh embodiment of the present invention will be described below.

When the user reserves the recording operation using the electronic program guide, the copy control information of the program contents is displayed on the electronic program guide using the methods shown in the first to sixth embodiments and the user reserves the recording operation based on the information. Suppose, however, that the copy control information of the program really changes at the time of starting the reserve-recording operation due to the fact that the right copy control information cannot be previously obtained or the broadcasting station side changes the copy control information at the last minute. When the copy control information changes from looser copy control information (e.g., “Copy one generation” and “Copy free plural number”) to severer copy control information (e.g., “Copy one generation), or just before starting the reserve-recording operation when understanding that the program has looser copy control information, inconvenience for the user occurs. For example, since it was determined that the program would not have looser copy control information, the recording operation onto the copyright management non-correspondence medium was reserved; however, the program actually has looser copy control information. The recording operation onto the copyright management non-correspondence medium is performed, and therefore, the looser copy control information is lost. As a result, the user-friendliness is impaired.

To cope with the above-described problem, at the time of starting the reserve-recording operation, when the copy control information is obtained from the PSI information of the program and when the program has looser copy control information (e.g., “Copy one generation” and “Copy free plural number”) and the copyright management correspondence medium is provided on the recording and reproducing apparatus, the recording operation is performed onto the copyright management correspondence medium. On this occasion, a message to the effect that the recording destination is changed is notified to the user. As for the mechanism for notifying the user of the message, at the time of the switching, the message may be displayed on a screen such as a display, or the message to the effect that the recording destination is changed may be recorded in a reservation recording performance history. Alternatively, at the time of the switching, the message to the effect that the recording destination is changed may be transmitted to a mail address that is previously registered. On the contrary, when the copy control information turns out to be not looser but severer at the time of performing the reserve-recording operation, the recording destination need not be changed as described above. However, the message to the effect that the copy control information changes or is wrong may be notified to the user. As for the mechanism for notifying the user of the message, when the information turns out to change or be wrong, the message may be displayed on a screen such as a display, or the message may be recorded in the reservation recording performance history. Alternatively, when the information turns out to change or be wrong, the message may be transmitted to the mail address previously registered.

As described above, even when the copy control information at the time of starting a reserve-recording operation is different from that at the time of reserving the recording operation, the reserve-recording operation can be performed without impairing the user-friendliness. As a result, the user-friendliness can be improved.

It should be further understood by those skilled in the art that although the foregoing description has been made on embodiments of the invention, the invention is not limited thereto and various changes and modifications may be made without departing from the spirit of the invention and the scope of the appended claims.

1. A receiving apparatus, comprising:
a receiver configured to receive information of a plurality of programs and each copy control information of the plurality of programs;
a reservation video recording section configured to reserve a recording operation so as to record the program onto a recording medium; and
a recording control unit configured to control the recording operation to be performed onto the recording medium, wherein:
when the copy control information of the program is changed, the recording control unit controls a recording destination to be changed to a recording medium different from the recording medium.

2. The receiving apparatus according to claim 1, further comprising:
a display control unit configured to control information received by the receiver to be displayed, wherein:
when the copy control information of the program is changed at the time of starting a reserve-recording operation, the display control unit controls a message to the effect that the information is changed to be displayed.

3. The receiving apparatus according to claim 1, wherein:
when the recording medium before the change is a recording medium in which a copyright cannot be managed, the copy control information before the change at the time of reserving the recording operation is not “Copy free multiple”, and the copy control information after the change is “Copy free multiple”, the recording control unit controls a recording destination to be changed to a recording medium in which a copyright can be managed.

4. The receiving apparatus according to claim 3, further comprising:
a display control unit configured to control information received by the receiver to be displayed, wherein:
when the recording medium is changed as a recording destination from a recording medium in which a copyright cannot be managed to a recording medium in which a copyright can be managed under the control of the display control unit, the display control unit controls a message to the effect that the recording medium is changed to be displayed.

5. A receiving apparatus, comprising:
a receiver configured to receive information of a plurality of programs and each copy control information of the plurality of programs;
a reservation video recording section configured to reserve a recording operation so as to record the program onto a recording medium; and
a recording control unit configured to control the recording operation to be performed onto the recording medium, wherein:
when the receiver receives the copy control information, the recording control unit controls the recording operation to be performed onto a recording medium according to the copy control information.

6. The receiving apparatus according to claim 5, further comprising:
a display control unit configured to control information received by the receiver to be displayed, wherein:
when the receiver receives the copy control information, the display control unit controls a recording medium according to the copy control information to be displayed.

7. A receiving apparatus, comprising:
a receiving means configured to receive programs in a plurality of broadcast networks and data including information of the programs;
a program guide preparing means configured to prepare a program guide based on the information of the programs; and
a display controlling means configured to control a program guide prepared by the program guide preparing means to be displayed, wherein:
the display controlling means controls information relating to copy control according to the broadcast networks to be displayed on the program guide.

8. The receiving apparatus according to claim 7, further comprising:
a determining means configured to determine the broadcast network, wherein:
when the determining means determines that the broadcast network is a terrestrial digital broadcasting, a BS free broadcasting, or a CS free broadcasting, the display controlling means controls predetermined allowable number of copies information to be displayed on the program guide.

9. The receiving apparatus according to claim 7, wherein:
the information relating to the copy control information includes copy generation management information or the allowable number of copies information.

10. A receiving apparatus, comprising:
a first receiving means and second receiving means configured to receive information of a plurality of programs and each copy control information of the plurality of programs;
a recording means configured to record the program information and copy control information received by the first receiving means;
a program guide preparing means configured to prepare a program guide using the information of the programs received by the second receiving means; and
a display controlling means configured to control the program guide prepared by the program guide preparing means to be displayed, wherein:
when the program information recorded in the recording means corresponds with the program information of the program guide, the copy control information recorded in the recording means is displayed on the program guide.

11. The receiving apparatus according to claim 10, wherein:
the program information is a name or content ID of the program; and
when the program name or content ID recorded in the recording means corresponds to the program name or content ID of the program guide, the information relating to copy control recorded in the recording means is displayed on the program guide.

12. The receiving apparatus according to claim 10, wherein:
the information relating to copy control includes copy generation management information or allowable number of copies information.

13. A receiving apparatus, comprising:
a first receiver configured to receive information of a plurality of programs;
a second receiver configured to receive copy control information of the programs via a network;
a program guide preparing means configured to prepare a program guide using the program information received by the first receiver and the copy control information received by the second receiver; and
a display controlling means configured to control the program guide prepared by the program guide preparing means to be displayed.

14. The receiving apparatus according to claim 13, wherein:
the program guide preparing means controls copy generation management information or allowable number of copies information to be displayed on the program guide using the copy control information received by the second receiver.
